(19) United States
(12) Patent Application Publication
(10) Pub. No.: US 2010/0207872 A1
(43) Pub. Date: Aug. 19, 2010

(54) OPTICAL DISPLACEMENT DETECTING DEVICE AND OPERATING METHOD THEREOF

(75) Inventors: Hsin Chia CHEN, Hsin-chu (TW); Tzung Min Su, Hsin-Chu (TW); Tzu Yi Chao, Hsin-Chu (TW)

Correspondence Address: LOWE HAUPTMAN HAM & BERNER, LLP, 1700 DIAGONAL ROAD, SUITE 300, ALEXANDRIA, VA, 22314, US

(73) Assignee: PIXAR IMGAGIN INC., Hsin-Chu (TW)

(21) Appl. No.: 12/612,491

(22) Filed: Nov. 4, 2009

(30) Foreign Application Priority Data
Feb. 17, 2009 (TW) 098104932

(51) Int. Cl. G09G 5/00

(52) U.S. Cl. 345/156

(57) ABSTRACT

An operating method of an optical displacement detecting device includes the steps of: capturing a plurality of images; obtaining a displacement according to the images; obtaining a characteristic variation of the images; and suppressing the output of the displacement when the characteristic variation matches a predetermined rule. The present invention further provides an optical displacement detecting device.

### CROSS REFERENCE TO RELATED APPLICATION

This application claims the priority benefit of Taiwan Patent Application Serial Number 098104932, filed on Feb. 17, 2009, the full disclosure of which is incorporated herein by reference.

### BACKGROUND

1. Field of the Invention

This invention generally relates to an optical displacement detecting device and operating method thereof and, more particularly, to an optical displacement detecting device and operating method thereof that can remove interferences from environmental artificial light sources.

2. Description of the Related Art

Conventionally, the position of a cursor shown on a screen is controlled through a mechanical displacement detector, e.g. a wheel mouse. A mouse ball is disposed inside this kind of mechanical displacement detector which is generally operated by a user on a specific surface, e.g. the surface of a mouse pad. But the conventional mechanical displacement detector can not be used on arbitrary surfaces and therefore has its limitation. In addition, when it is used for a period of time, malfunction and operation failure may occur due to the mechanism deterioration and accumulation of dirt. In this manner, an optical displacement detecting device, e.g. an optical mouse, has been proposed to replace the conventional mechanical displacement detector.

Although the optical displacement detecting device has a similar appearance as traditional mechanical displacement detector, since the optical displacement detecting device does not have a mouse ball therein, its operational efficiency will not degrade with use and it can be operated on almost any surface. However, this kind of optical displacement detecting device is not suitable for portable devices, e.g. note books, cell phones or PDAs. Therefore, the optical displacement detecting device that can be equipped directly on portable devices has been proposed in recent years and it can operate well without the need of being moved on a surface.

For example, U.S. Pat. No. 6,057,540, entitled MOUSELESS OPTICAL AND POSITION TRANSLATION TYPE SCREEN POINTER CONTROL FOR A COMPUTER SYSTEM, discloses an optical displacement detecting device. However, the optical displacement detecting device will be influenced easily by environmental artificial light sources during operation to cause malfunction even without being triggered by the finger of a user. For example, when the detecting device is in resting state, it will be influenced by environmental artificial light sources to cause cursor jitter. Or when the detecting device is being moved, it will automatically output displacement signals to cause cursor drifting.

Accordingly, it is necessary to provide an optical displacement detecting device which can remove interferences from environmental artificial light sources to avoid malfunction of the optical displacement detecting device.

### SUMMARY

The present invention provides an optical displacement detecting device and operating method thereof, which can distinguish between the light source of the optical displacement detecting device itself and the outside artificial light sources through detecting the fixed frequency of the outside artificial light sources so as to remove the interference therefrom.

The present invention provides an optical displacement detecting device and operating method thereof, wherein the optical displacement detecting device will not automatically output displacement signals when it is being moved in an environment containing artificial light sources to increase its operational stability.

The present invention provides an optical displacement detecting device including an image sensor, a light source and a processing unit. The image sensor is for capturing a plurality of images. The light source provides light to the image sensor during image capturing. The processing unit is coupled to the image sensor, obtains a displacement and a characteristic variation according to the images and determines whether to output the displacement according to the characteristic variation.

The present invention further provides an operating method of an optical displacement detecting device comprising the steps of: capturing a plurality of images; obtaining a displacement according to the images; obtaining a characteristic variation of the images; and suppressing the output of the displacement when the characteristic variation matches a predetermined rule.

The present invention further provides an operating method of an optical displacement detecting device comprising the steps of: capturing a plurality of images; obtaining a displacement according to the images; obtaining an average brightness of each image; defining decision periods in which the average brightness of successive images is monotonically increasing or monotonically decreasing; and suppressing the output of the displacement when the number of the images is within a predetermined range in a predetermined number of successive decision periods.

In the optical displacement detecting device and operating method thereof, a characteristic variation, e.g. the change of the average brightness, of captured images is analyzed to determine whether the displacement detecting device is interfered by environmental artificial light sources. For example, when the average brightness of the images changes continuously with a fixed frequency within a predetermined time periods, it is able to determine that the change of the average brightness is caused by environmental artificial light sources and the obtained displacement will not be treated as an actual detected displacement. In this manner, malfunction of the displacement detecting device can be avoided.

### BRIEF DESCRIPTION OF THE DRAWINGS

Other objects, advantages, and novel features of the present invention will become more apparent from the following detailed description when taken in conjunction with the accompanying drawings.

FIG. 1 shows a schematic diagram of an optical displacement detecting device in accordance with an embodiment of the present invention.

FIG. 2 shows a block diagram of the image sensing module in accordance with an embodiment of the present invention.

FIG. 3 shows a schematic diagram of the method for detecting environmental artificial light sources in the present invention.

FIG. 4 shows a flow chart of the operating method of the optical displacement detecting device in accordance with an embodiment of the present invention.

### DETAILED DESCRIPTION OF THE EMBODIMENT

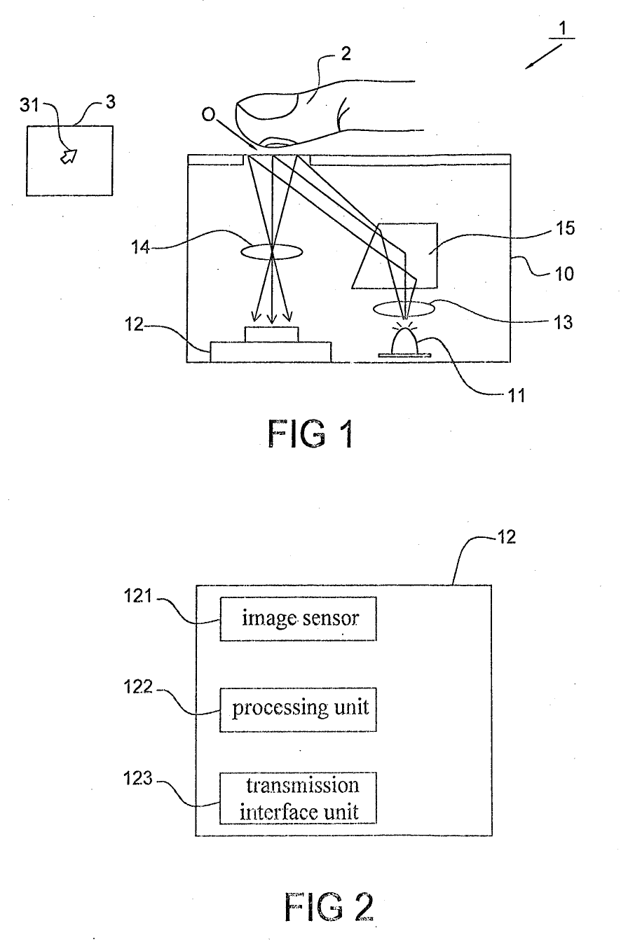

Please refer to FIG. 1, it shows a schematic diagram of the optical displacement detecting device 1 in accordance with an embodiment of the present invention. The optical displacement detecting device 1 is for detecting the position variation of an object 2 so as to accordingly control the operation of an image display 3, e.g. controlling the movement of a cursor 31 shown on the image display 3 or the operation of software installed inside the image display 3. In this embodiment, although the object 2 is shown as a finger, it is not used to limit the present invention; and the object 2 may be a rod, a pen or other suitable objects. For example, when the object 2 is a finger, the optical displacement detecting device 1 detects the variation of images of the fingerprint on the finger so as to determine the displacement of the finger (object 2). A processing unit converts the variation of images to digital signals which will then be electrically or wirelessly transmitted, through a transmission interface unit, to the image display 3 to perform corresponding operation. The image display 3 may be, for example, a television, a computer screen, a projection screen or the screen of a game machine.

Please refer to FIGS. 1 and 2, the optical displacement detecting device 1 may have a housing 10 which may be made from, for example, IR transparent material and may have an opening “O” on its top. The object 2 moves in front of the opening “O”. However, the opening “O” is not necessary to be formed on the top of the housing 10. Inside the housing 10, there are a light source 11 and an image sensing module 12. The light source 11 may be an IR light source, e.g. an IR light emitting diode or an IR laser diode. In one embodiment, the image sensing module 12 includes an image sensor 121, a processing unit 122 and a transmission interface unit 123, as shown in FIG. 2. The image sensor 121 may be, for example, a CCD image sensor or a CMOS image sensor. The processing unit 122 may be, for example, a digital signal processor (DSP). The transmission interface unit 123 may be a wired transmission interface or a wireless transmission interface for communicating with the image display 3. In another embodiment, the image sensor 121, the processing unit 122 and the transmission interface unit 123 may be disposed separately.

Light emitted from the light source 11 will be reflected by the object 2 in front of the opening “O”. The image sensor 121 receives the reflected light so as to capture a plurality of images and transmits the images to the processing unit 122. The processing unit 122 calculates the displacement of the object 2 according to the image variation of the object 2 between images, e.g. calculating the displacement according to the correlation between two images or other conventional methods, and obtains a characteristic variation of the images according to several successive images so as to determine whether the displacement is caused by the interference from environmental artificial light sources (details will be illustrated below), wherein the characteristic may be, for example, an average brightness of each image. When it is determined that the calculated displacement is not caused by the interference from environmental artificial light sources, the displacement will be sent to the transmission interface unit 123 for transmitting. When it is determined that the calculated displacement is caused by the interference from environmental artificial light sources, the processing unit 122 suppresses the output of the displacement. In addition, the optical displacement detecting device 1 may further includes a lens (or lens set) 13 disposed in front of the light source 11 for adjusting the light emitted by the light source 11, a lens (or lens set) 14 disposed in front of the image sensing module 12 for adjusting its sensing efficiency, a light guiding unit 15 for guiding the light emitted from the light source 11 to the opening “O” of the housing 10. In one embodiment, the lens 13 may be formed integrally with the light guiding unit 15. The light guiding unit 15 may be made from suitable IR transparent material.

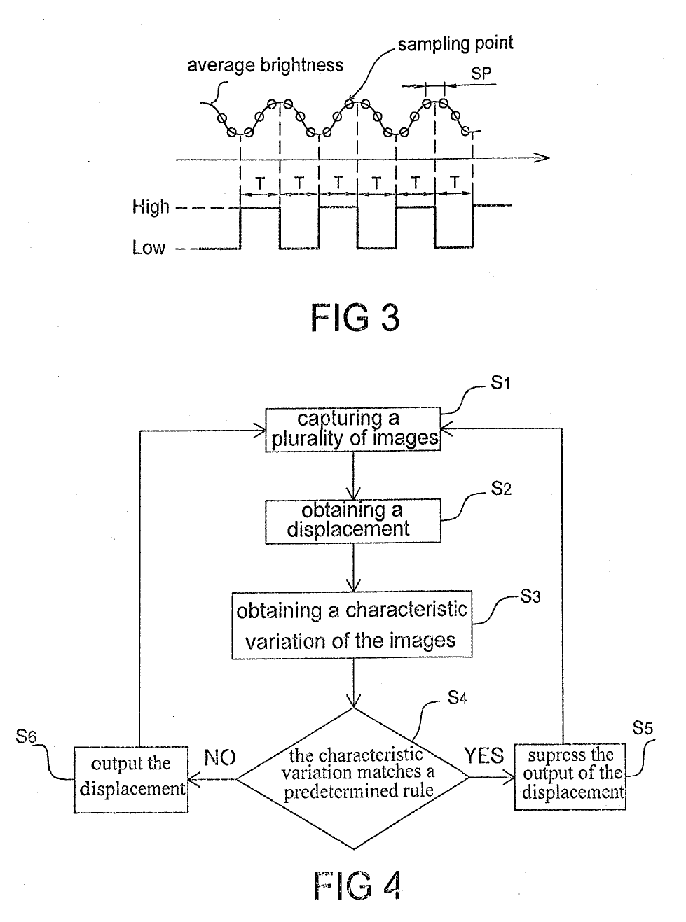

The method to determine whether the displacement is caused by environmental artificial light sources used in the present invention will be illustrated hereinafter. Please refer to FIG. 3, it shows a schematic diagram for identifying the interference from environmental artificial light sources in the present invention. Because the brightness of artificial light sources, e.g. fluorescent lights and halogen lights, generally has a fixed change frequency, e.g. 60 Hz in Taiwan and America and 50 Hz in China, the present invention determines whether the displacement detected by the optical displacement detecting device 1 is caused by environmental artificial light sources through identifying whether an average brightness of a plurality of images captured by the image sensor 121 has a fixed change frequency.

Please refer to FIG. 4, it shows a flow chart of the operating method of the optical displacement detecting device 1 according to the embodiment of the present invention. The operating method includes the steps of capturing a plurality of images (Step S₁); obtaining a displacement according to the images (Step S₂); obtaining a characteristic variation of the images (step S₃); identifying whether the characteristic variation matches a predetermined rule (Step S₄); if yes, suppressing the output of the displacement (Step S₅); if no, outputting the displacement (Step S₆);

Please refer to FIGS. 3 and 4 again, in this embodiment, it is assumed that an image sampling frequency of the image sensor 121 is 800 Hz (i.e. sampling period “SP” is 1.25 ms). It is further assumed that the frequency of environmental artificial light sources is 60 Hz; and thus the change frequency of the average brightness of images captured by the image sensor 121 is 120 Hz, i.e. a change cycle of the average brightness is about 8.33 ms. At first, the image sensor 121 captures a plurality of images with the predetermined sampling frequency (Step S₁). Next, the processing unit 122 obtains a displacement according to a relationship between the images, e.g. the correlation between successive images (Step S₂). In another embodiment, when the frequency of the environmental artificial light sources is 50 Hz, the change frequency of the average brightness of images captured by the image sensor 121 is 100 Hz, i.e. a change cycle of the average brightness is 10 ms.

Then, the processing unit 122 obtains a characteristic variation of the images (Step S₃). When the images are interfered by environmental artificial light sources, the average brightness of the images will appear a periodic change in which the average brightness of the images will monotonically increase within half of a change cycle (4.17 ms) of the average brightness and will monotonically decrease within next half of the change cycle (4.17 ms) of the average brightness. That is, the image sensor 121 will capture 3˜4 (4.17/1.25=3.336) successive images with monotonically increasing average brightness and then capture 3˜4 successive images with monotonically decreasing average brightness. When the average brightness of the images captured by the image sensor 121 is increasing, the processing unit 122 generates a high level signal (i.e. 1); on the contrary, when the average brightness of the images captured by the image sensor 121 is decreasing, the processing unit 122 generates a low level signal (i.e. 0). In this embodiment, each high level period and low level period is defined as a decision period “T”, i.e. each decision period “T” is about a half of the change cycle of the average brightness of the images.

The processing unit 122 determines whether the characteristic variation matches a predetermined rule (Step S₄), e.g. determining whether the average brightness of the images has a fixed change frequency. In one embodiment, the processing unit 122 determines whether a sampling number (i.e. the number of sampled images) of the image sensor 121 is within a predetermined range within a predetermined number of successive decision periods “T” (e.g. 2˜4 decision periods “T”). In another embodiment, the processing unit 122 determines whether the sampling number of the image sensor 121 is within a predetermined range (e.g. 2˜5 sampled images) in each decision period “T” of a predetermined number of successive decision periods “T”. When one of the above embodiments is matched, it is able to determine that the average brightness of the images has a fixed change frequency, i.e. the characteristic variation matching the predetermined rule, and the processing unit 122 suppresses the output of the displacement (Step S₅); otherwise, the processing unit 12 outputs the displacement to the transmission interface unit 123 (Step S₆). Finally, the optical displacement detecting device 1 captures a new image again and determines whether to output the new displacement from Step S₁. The transmission interface unit 12 electrically or wirelessly transmits the displacement to the image display 3 for corresponding control. It should be understood that numbers given in the embodiments of the present invention are only illustrative and are not used to limit the present invention.

As mentioned above, because conventional optical displacement detecting device is not able to remove interferences from environmental artificial light sources to the device itself, it may cause cursor jitter and cursor shifting during idle. The present invention provides an optical displacement detecting device and operating method thereof (FIGS. 1 and 4), which can remove interferences from environmental artificial light sources through detecting the characteristic variation of captured images and thus has higher operational efficiency.

Although the invention has been explained in relation to its preferred embodiment, it is not used to limit the invention. It is to be understood that many other possible modifications and variations can be made by those skilled in the art without departing from the spirit and scope of the invention as hereinafter claimed.

What is claimed is:

1. An optical displacement detecting device, comprising:
an image sensor, for capturing a plurality of images;
a light source, providing light to the image sensor during image capturing;
a processing unit, coupled to the image sensor, obtaining a displacement and a characteristic variation according to the images and determining whether to output the displacement according to the characteristic variation.

2. The optical displacement detecting device as claimed in claim 1, wherein the characteristic is an average brightness of each image.

3. The optical displacement detecting device as claimed in claim 1, wherein when the characteristic variation matches a predetermined rule, the processing unit suppresses the output of the displacement.

4. The optical displacement detecting device as claimed in claim 3, wherein the predetermined rule is that an average brightness of the images has a fixed change frequency.

5. The optical displacement detecting device as claimed in claim 4, wherein the change frequency is 100 Hz or 120 Hz.

6. The optical displacement detecting device as claimed in claim 4, wherein the change frequency is fixed when the number of the images captured by the image sensor is within a predetermined range in a predetermined number of successive decision periods.

7. The optical displacement detecting device as claimed in claim 6, wherein the decision period is a period in which the average brightness of successive images is monotonically increasing or monotonically decreasing.

8. The optical displacement detecting device as claimed in claim 4, wherein the change frequency is fixed when the number of the images captured by the image sensor is within a predetermined range in each decision period of a predetermined number of successive decision periods.

9. The optical displacement detecting device as claimed in claim 8, wherein the decision period is a period in which the average brightness of successive images is monotonically increasing or monotonically decreasing.

10. The optical displacement detecting device as claimed in claim 1, further comprising a transmission interface unit for transmitting the displacement to an image display.

11. The optical displacement detecting device as claimed in claim 1, wherein the light source is an infrared light source.

12. An operating method of an optical displacement detecting device, comprising the steps of:
capturing a plurality of images;
obtaining a displacement according to the images;
obtaining a characteristic variation of the images; and
suppressing the output of the displacement when the characteristic variation matches a predetermined rule.

13. The operating method as claimed in claim 12, further comprising: outputting the displacement when the characteristic variation does not match the predetermined rule.

14. The operating method as claimed in claim 13, further comprising: transmitting the displacement to an image display.

15. The operating method as claimed in claim 12, wherein the characteristic is an average brightness of each image.

16. The operating method as claimed in claim 15, wherein the predetermined rule is that the average brightness has a fixed change frequency.

17. The operating method as claimed in claim 16, wherein the change frequency is 100 Hz or 120 Hz.

18. The operating method as claimed in claim 16, wherein the change frequency is fixed when the number of the images is within a predetermined range in a predetermined number of successive decision periods.

19. The operating method as claimed in claim 18, wherein the decision period is a period in which the average brightness of successive images is monotonically increasing or monotonically decreasing.

20. The operating method as claimed in claim 16, wherein the change frequency is fixed when the number of the images is within a predetermined range in each decision period of a predetermined number of successive decision periods.

21. The operating method as claimed in claim 20, wherein the decision period is a period in which the average brightness of successive images is monotonically increasing or monotonically decreasing.

22. An operating method of an optical displacement detecting device, comprising the steps of:
capturing a plurality of images;
obtaining a displacement according to the images;
obtaining an average brightness of each image;
defining decision periods in which the average brightness of successive images is monotonically increasing or monotonically decreasing; and
suppressing the output of the displacement when the number of the images is within a predetermined range in a predetermined number of successive decision periods.

23. The operating method as claimed in claim 22, further comprising: outputting the displacement when the number of the images is not within the predetermined range in a predetermined number of successive decision periods.

24. The operating method as claimed in claim 23, further comprising: transmitting the displacement to an image display.

25. The operating method as claimed in claim 22, wherein in the step of suppressing the output of the displacement, the output of the displacement is suppressed when the number of the images is within a predetermined range or the number of the images in each decision period is within a predetermined range in a predetermined number of successive decision periods.
